(19) United States
(12) Patent Application Publication
(10) Pub. No.: US 2016/0155081 A1
(43) Pub. Date: Jun. 2, 2016

(54) PROCESS FLOW HEADER

(71) Applicants: Vera Legisa, Karlsruhe (DE); Dagmar Mayer, Beilstein (DE); Bjoern Bader, Eppelheim (DE); Patrick Fischer, Ludwigshafen (DE); Timo Bess, Wiesloch (DE)

(72) Inventors: Vera Legisa, Karlsruhe (DE); Dagmar Mayer, Beilstein (DE); Bjoern Bader, Eppelheim (DE); Patrick Fischer, Ludwigshafen (DE); Timo Bess, Wiesloch (DE)

(21) Appl. No.: 14/556,036

(22) Filed: Nov. 28, 2014

(51) Int. Cl. G06Q 10/06; G06F 3/0481

(52) U.S. Cl. CPC G06Q 10/063114; G06F 3/04817

(57) ABSTRACT

A process flow status header that displays information on the status of a business process flow, including a status indicator, is added to the process flow control. A visualization of the percentage of completed or created items compared to missing or incomplete items and a distribution representative of the status of each step of the process flow is provided as part of the process flow status header. The process flow status header is a single control for accessing the associated process flow control from anywhere in the user interface.

### BACKGROUND

Aspects of the present invention relate generally to the field of information systems and computer software and more specifically to process flow interfaces.

A business process that represents a process of an enterprise is typically a collection of related activities or tasks that result in a particular business outcome or goal. For example, an operational business process can illustrate the activities and tasks necessary to complete a purchasing, manufacturing, marketing, or sales goal. Other business processes can include document flows or approval flows and can describe an accounting, recruitment, or technical goal. Business processes or workflows are conventionally modeled as a flowcharts and are often complex, including details about each step in the process such as the entities involved, the creation and storage of business objects and other relevant information, or the location and transfer of materials.

However, with all the various types of information conventionally included in a business process flow, even when optimally displayed, a user still must sort through and evaluate multiple elements of each task in order to determine the status of the process flow. Accordingly, there is a need in the art for a method to provide a quick and simple understanding of the status of a process flow.

### BRIEF DESCRIPTION OF THE DRAWINGS

FIG. 1 illustrates a process flow having an exemplary status header according to an embodiment of the present invention.

FIG. 2 illustrates an exemplary status indicator according to an embodiment of the present invention.

FIG. 3 illustrates an exemplary process flow status header according to an embodiment of the present invention.

FIG. 4 illustrates an exemplary method for displaying a process flow status header according to an embodiment of the present invention.

FIG. 5 is a simple block diagram illustrating components of an exemplary system according to an embodiment of the present invention.

FIG. 6 is a simple block diagram illustrating components of an exemplary system according to an embodiment of the present invention.

FIG. 7 is a simple block diagram illustrating components of an exemplary client according to an embodiment of the present invention.

### DETAILED DESCRIPTION

A process flow status header is displayed as part of the process flow control in a process flow control interface. The simple, quick, and easy visualization provided in the process flow status header offers the user information on the status of a business process flow at a glance by providing a visualization of the percentage of completed or created items compared to missing or incomplete items and a distribution representative of the status of each task of each step of the process flow.

The process flow status header can be used as a single control to access the process flow control from anywhere in the user interface (e.g., home and overview pages). The process flow status header can be provided throughout the various displays of the user interface to provide a single abbreviated control for complete access to the full process flow. For example, the process flow status header can be provided without showing the whole process flow itself or the associated detailed textual description.

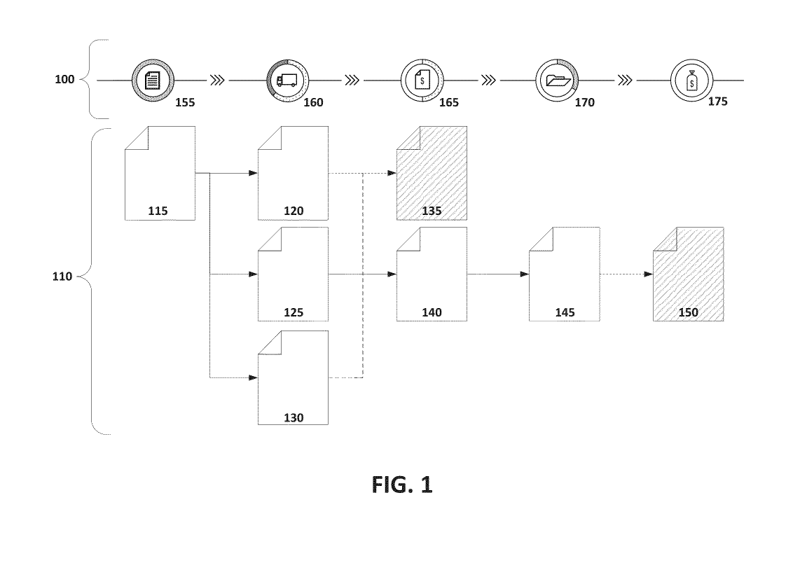

FIG. 1 illustrates a process flow 110 having an exemplary status header 100 according to an embodiment of the present invention. As shown in FIG. 1, the process flow 110 can include multiple process flow tasks or elements 115-150, each forming a part of a process flow item or step. The status of each step is visually presented as part of the status header 100 in an associated process flow status indicator 155-175.

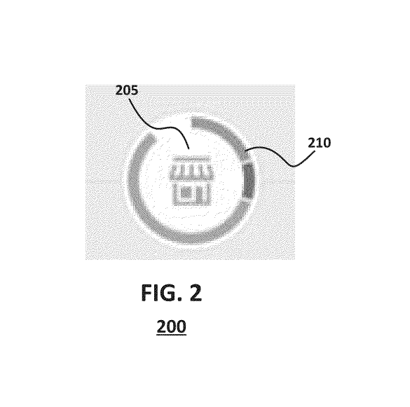

FIG. 2 illustrates an exemplary status indicator 200 according to an embodiment of the present invention. As shown in FIG. 2, a status indicator can include an image 205 and a meter 210 that indicates the status of the tasks or elements in the associated process flow step. For example, the image 205 can be any image associated with the associated process flow step, including an icon or other graphic that represents the process flow item. This graphic can be used in other throughout the process flow organizational program to represent the step of the process flow or can be derived from an element in the process flow step. In order to distinguish between process flow steps, a graphic should not be used for more than one process flow status indicator in the status header.

Additionally, as shown in FIG. 2, a meter 210 is provided that indicates the status of the process flow step. For example, the meter 210 can be a pie chart that shows the percentage of elements or tasks of the process flow step that are created and positive (e.g., done), the percentage of elements or tasks of the process flow step that have not yet been created or initiated (e.g., open), the percentage of elements or tasks of the process flow step that are created and negative (e.g., have an issue), and the percentage of elements or tasks of the process flow step that are created and neutral (e.g., in progress).

According to an embodiment, the meter will include one or more colors that visually represent the status of the process flow item. For example, a portion of the meter in the process flow status indicator can be a neutral color, such as a gray color, for items in the process flow that are in progress; a negative color, such as a red color, for items in the process flow that have an issue; and a positive color, such as a green color, for items in the process flow that have been successfully completed. Additionally, for items that have not been started, have not been created, or otherwise are not yet in progress, the status indicator may be displayed as a neutral color, or have no color fill. Other colors additionally are contemplated and can form part of the visualization provided by the process flow status indicator.

According to an embodiment, the percentage of items in each category (not started, in progress, complete, or having an issue) will be presented as part of the process flow status indicator visualization. For example, if fifty percent of a process flow step is complete and the remaining fifty percent is in progress, the process flow status indicator will include an element or a meter that is filled half with a positive color and half with a neutral color as described above. Therefore, a user will be able to determine the status of the process flow with only a glance at the process flow status indicator.

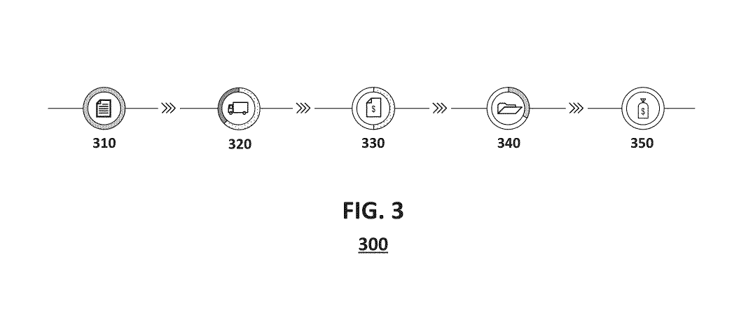

FIG. 3 illustrates an exemplary process flow status header 300 according to an embodiment of the present invention. As shown in FIG. 3, the process flow status header 300 includes multiple status indicators 310-350, each which visually displays the status of the process flow steps associated with the respective status indicator.

For example, as illustrated, status indicator 310 is associated with a first process flow step. The status indicator 310 shows that all the items for this step are created and are in progress as the meter has been filled in a neutral color (e.g. gray). Status indicator 320 shows that all the items associated with this step are created and in progress as the meter has been completely filled in. However, an element or elements representing one third of the process step has an issue as one-third of the meter has been filled in a negative color (e.g., red) and elements representing two thirds of the process step are done as two-thirds of the meter have been filled in a positive color (e.g., green). Status indicator 330 shows that one half of the necessary elements for the associated process flow step are created and completed as one half of the meter has been filled in a positive color (e.g., green), however, the other half of the elements have not yet been initiated as one half of the meter has not yet been filled. Status indicator 340 shows that one third of the necessary elements for the associated process flow step are created and in progress as one third of the meter has been filled in a neutral color (e.g. gray), however, the other two thirds of the elements have not yet been initiated as two thirds of the meter has not yet been filled. Status indicator 350 shows that none of the elements of the associated process flow step have been initiated as the meter has not yet been filled.

According to an embodiment, if all elements or tasks of a step are completed the meter is filled completely in a positive color (e.g., green). Then, when all of the meters in the status indicator header are completely filled with a positive (e.g., green) color, then all the steps of the process flow have been completed and the process flow is finished.

According to an embodiment, and as shown in FIG. 3, a process flow status header is drawn with a line connecting the circles representing the process flow status indicators positioned at regular intervals. Each circle or status indicator represents one step in the process flow. The name of the process flow step can provided below the respective circle to summarize the process flow step and to aid understanding (not shown). As previously noted, inside each circle is an icon or image representative of the associated process flow step. A circular process bar or meter around the icon indicates the percentage distribution of statuses of all elements associated with the respective step of the process flow.

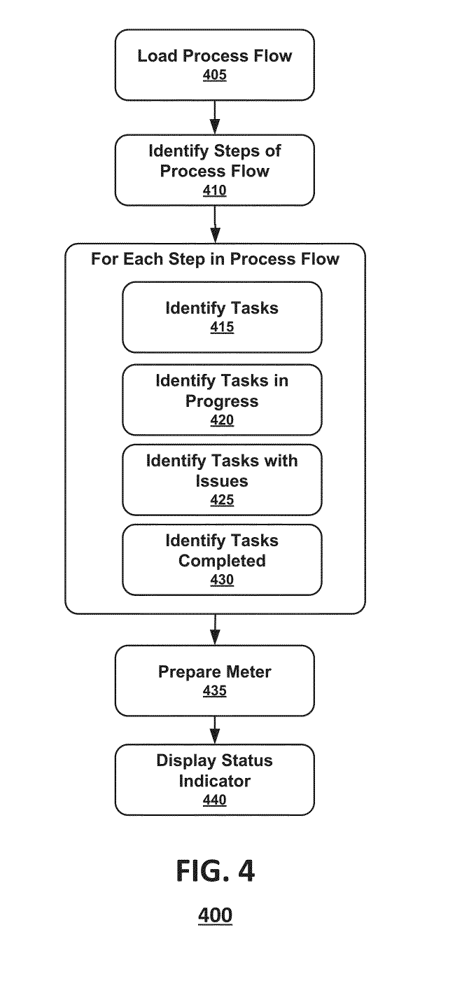

FIG. 4 illustrates an exemplary method for displaying a process flow status header according to an embodiment of the present invention. As shown in FIG. 4, a process view overview page is initially loaded onto a display (block 405). Then a status indicator header is created as described herein. For example, each of the multiple steps of the process flow are identified (block 410). Then, for each identified step, a status meter is populated (block 435). To populate the status meter, for each step in the process flow, one or more tasks or elements of the step are identified (block 415). Then the percentage of identified tasks that are in progress (block 420), that have an issue (block 425), and that are completed (block 430) is calculated. The calculated percentage is used to fill the meter (block 435). Additionally, an icon or other image associated with the respective process flow step is identified, retrieved from memory if necessary, and displayed (not shown). Then the image and meter are added to header displayed on the user interface (block 440). The status meters of the status indicator header can be periodically refreshed, for example the status meter may be recalculated at regular intervals or when an update to an associated task is detected (not shown).

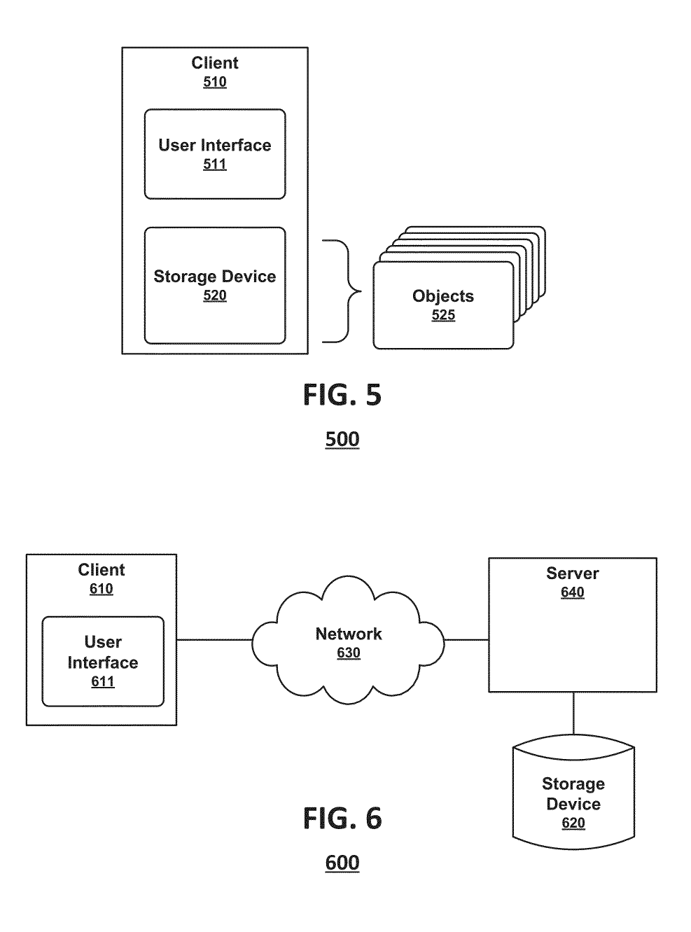

A user may access a process flow display in a standalone client system, client-server environment, or a networked environment. FIG. 5 is a simple block diagram illustrating components of an exemplary system 500 according to an embodiment of the present invention. As shown in FIG. 5, a system 500 may comprise a client 510 having a user interface 511 and a storage device 520. A plurality of business objects 525 may be stored in the storage device 520 in the client's local memory. The client 510 may be any computing system that facilitates a user accessing a storage device 520 of objects, for example a personal computer or other computing device. The storage device 520 may be any object storage device, for example, a disk drive or a database. If the plurality of business objects 525 are stored in a database, the status information for each object may be stored in the record of the object 525. The object and the related information may then be retrieved by querying the database.

A user may access the plurality of business objects 525 stored in the storage device 520 from the client 510 via a user interface 511 capable of accessing the storage device 520 and displaying a process flow status header as described herein, the plurality of objects 525, and related metadata stored in the storage device 520. The user interface 511 may be a program or application or may comprise middleware that acts as a frontend to or otherwise facilitates access to the storage device 520. The user may interact with the user interface 511 through an input device, such as by inputting a selection as with a mouse or inputting a selection as with a keyboard. The user may observe the response to the selection on an output device or display. In accordance with an aspect of the invention, the user interface 511 may run in a browser window controlled by the user. In another aspect of the invention, the user interface 511 may run in an application window controlled by the user.

FIG. 6 is a simple block diagram illustrating components of an exemplary system 600 according to an embodiment of the present invention. As shown in FIG. 6, system 600 may comprise a client 610 having a user interface 611. The client 610 may be connected to a server 640 via a network 630. A user may access a process flow and a plurality of related business objects stored in the server 640 at a storage device 620. The user interface 611 may be any interface capable of accessing and displaying objects stored at the storage device 620. The network 630 may be a wired or wireless network that may include a local area network (LAN), a wireless network, the Internet, or any other network available for accessing the storage device 620 via the client 610 with the user interface 611.

The server 640 may be a network server accessible to the client 610 via the network 630 that may manage access to storage device 620. The user interface 611 may receive instructions regarding the process flow from the user and, utilizing the objects stored in memory storage 620, facilitate a display of the simulation or the information gathered during the simulation. Multiple different clients (not shown) may access storage device 620 via the network 630 and request access to the objects stored therein.

In another networked environment, the process flow display may be executed on a network capable client and access the business other objects stored in one or more storage devices via a network and communications server.

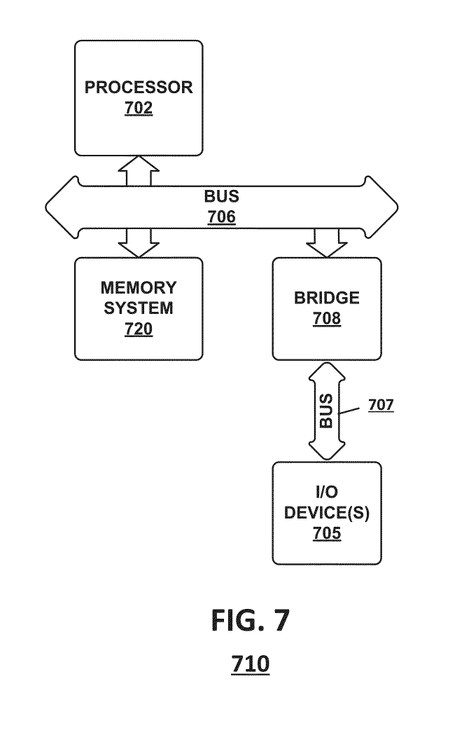

FIG. 7 is a simple block diagram illustrating components of an exemplary client 710 according to an embodiment of the present invention. As shown in FIG. 7, a client 710 configured to display the business process flow as described herein may include a processor 702, a memory system 720 and one or more input/output (I/O) devices 705 in communication. The communication can be implemented in a variety of ways and may include one or more computer buses 706, 707 and/or bridge devices 708 as shown in FIG. 7. The I/O devices 705 can include network adapters and/or mass storage devices from which the client 710 can receive commands for executing the process flow display.

In some applications, the modules described hereinabove may be provided as elements of an integrated software system, in which the blocks may be provided as separate elements of a computer program. Some embodiments may be implemented, for example, using a non-transitory computer-readable storage medium or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the modules described herein need be provided or need be provided as separate units. Additionally, it is noted that the arrangement of the blocks in FIG. 4 do not necessarily imply a particular order or sequence of events, nor are they intended to exclude other possibilities. Such implementation details are immaterial to the operation of the present invention unless otherwise noted above.

The exemplary methods and computer program instructions may be embodied on a non-transitory computer readable storage medium that may include any medium that can store information. Examples of a computer readable storage medium include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

While the invention has been described in detail above with reference to some embodiments, variations within the scope and spirit of the invention will be apparent to those of ordinary skill in the art. Thus, the invention should be considered as limited only by the scope of the appended claims.

We claim:

1. A method for displaying a process flow status header comprising:
retrieving a process flow having a plurality of steps from a memory;
for each step in the process flow, identifying at least one task necessary to complete the step;
for each of the identified tasks, determining a status of the respective task; and
displaying a status indicator for each step in the process flow, wherein the status indicator illustrates the status of the at least one task associated with the step.

2. The method of claim 1, wherein the status indicator for each step further includes an icon representative of the step.

3. The method of claim 1, wherein a status of each task associated with the respective step is displayed as a percentage of a meter.

4. The method of claim 1, wherein the status of the at least one task associated with the step is displayed in the status indicator as a color.

5. The method of claim 4, wherein a neutral color indicates that the task is in progress, a positive color indicates that the task has been completed, a negative color indicates that there is an issue with the task, and no color indicates that the task has not been initiated.

6. A system for displaying a process flow status header comprising:
a memory to store a process flow having a plurality of steps;
a user interface to display the process flow; and
a processor configured to retrieve the process flow from the memory, for each step in the process flow, to identify at least one task necessary to complete the step, for each identified task, to determine a status of the respective task, and to output to the display a status indicator for each step in the process flow, wherein the status indicator illustrates the status of the at least one task associated with the step.

7. The system of claim 6, wherein the status indicator for each step further includes an icon representative of the step.

8. The system of claim 6, wherein a status of each task associated with the respective step is displayed as a percentage of a meter.

9. The system of claim 6, wherein the status of the at least one task associated with the step is displayed in the status indicator as a color.

10. The system of claim 9, wherein a neutral color indicates that the task is in progress, a positive color indicates that the task has been completed, a negative color indicates that there is an issue with the task, and no color indicates that the task has not been initiated.

11. The system of claim 6, wherein the processor is implemented on a network server.

12. The system of claim 6, wherein the user interface is a browser.

13. The system of claim 6, wherein the status header is a constant part of the user interface.

14. A non-transitory computer readable medium storing instructions that when executed by a processor, cause the processor to perform a method comprising:
retrieving a process flow having a plurality of steps from a memory;
for each step in the process flow, identifying at least one task necessary to complete the step;
for each of the identified tasks, determining a status of the respective task; and
displaying a status indicator for each step in the process flow, wherein the status indicator illustrates the status of the at least one task associated with the step.

15. The non-transitory computer readable medium of claim 14, wherein the status indicator for each step further includes an icon representative of the step.

16. The non-transitory computer readable medium of claim 14, wherein a status of each task associated with the respective step is displayed as a percentage of a meter.

17. The non-transitory computer readable medium of claim 14, wherein the status of the at least one task associated with the step is displayed in the status indicator as a color.

18. The non-transitory computer readable medium of claim 17, wherein a neutral color indicates that the task is in progress, a positive color indicates that the task has been completed, a negative color indicates that there is an issue with the task, and no color indicates that the task has not been initiated.
